(19) United States
(12) Patent Application Publication
(10) Pub. No.: US 2015/0046444 A1
(43) Pub. Date: Feb. 12, 2015

(54) ADAPTIVE PERSONALIZED RANKING METHOD OF NODES IN A DATABASE

(71) Applicant: Ehsan AFKHAMI, Cambridge, MA (US)

(72) Inventor: Ehsan AFKHAMI, Cambridge, MA (US)

(21) Appl. No.: 14/521,073

(22) Filed: Oct. 22, 2014

Related U.S. Application Data
(63) Continuation of application No. PCT/US2013/037631, filed on Apr. 22, 2013.
(60) Provisional application No. 61/799,852, filed on Mar. 15, 2013.
(60) Provisional application No. 61/772,175, filed on Mar. 4, 2013.
(60) Provisional application No. 61/758,504, filed on Jan. 30, 2013.
(60) Provisional application No. 61/797,564, filed on Dec. 11, 2012.
(60) Provisional application No. 61/687,280, filed on Apr. 23, 2012.

(51) Int. Cl. G06F 17/30

(52) U.S. Cl. CPC G06F 17/3053
USPC 707/732

(57) ABSTRACT

A method and apparatus for re-ranking a current search result by evaluating previous actions of other users, who acted similarly to a target user on previous queries unrelated to the current search result, with respect to an information node returned in the current search result.

### CROSS-REFERENCES TO RELATED APPLICATIONS

The present application is a Continuation of PCT application number PCT/US2013/037631 having an international filing date of Apr. 22, 2013 the disclosure of which is herewith incorporated by reference in its entirety, which in turn claims the benefit of United State provisional patent application No. 61/687,280 filed on Apr. 23, 2012, and of U.S. provisional patent application No. 61/797,564 filed on Dec. 11, 2012, and of U.S. provisional patent application No. 61/758,504 filed on Jan. 30, 2013 and of U.S. provisional patent application No. 61/772,175 filed on Mar. 4, 2013 and of U.S. provisional patent application No. 61/799,852 filed on Mar. 15, 2013, the disclosures of each of which are incorporated herewith by reference in their entirety.

### SUMMARY

Due to the developments in computer technology and its increase in popularity, large numbers of people are frequently searching huge databases. For example, Internet search engines are frequently used to search the entire World Wide Web. Currently, a popular search engine might execute over 1 billion searches per day of the index-able part of the web; with an excess of a trillion unique URLs on the World Wide Web. Many people have also been joining and contributing significant amounts of information in the form of status updates, pictures, events information, local retailer reviews amongst others to the databases of online social networking websites.

Currently there are over a 100 million posts made and read daily by users of popular social networking websites; with the top social networking sites reporting over a billion active users per month. Still, many people receive hundreds of on-line recommendations for what to purchase from on-line and brick and mortar retailers through email or recommendation lists presented to them on a retailer's website. Currently, a successful on-line retailer has an excess of 5 billion dollars of sales annually.

It is important to note that the mentioned cases, namely a user being presented with search results from the World Wide Web, posts from other users of a social networking website or a list of recommended items to purchase, the same process is occurring. That is, a database containing many nodes of information is searched as a result of a query initiated by a user. In all these cases a query is constructed based on a combination of the user's previous interactions with the database and a keyword input by the user. The results are then presented to the user in a list, usually sorted according to an importance ranking of each node.

Information retrieval systems are traditionally judged by their precision and recall. What is often neglected, however, is the personalization of search results to the user performing the search by these search engines. As a result, World Wide Web and other database searches typically return hundreds of irrelevant or unwanted documents that camouflage the few relevant ones. In order to improve the selectivity of the results, common techniques allow the user to constrain the scope of the search to a specified subset of the database, or to provide additional search terms. These techniques are most effective in cases where the database is homogeneous and already classified into subsets, or in cases where the user is searching for well-known and specific information. In other cases, however, these techniques are often not effective because each constraint introduced by the user increases the chances that the desired information will be inadvertently eliminated from the search results.

In the case of social networking websites, users proactively cause connections with other users that they feel they have a connection with such as friends, experts, celebrities or professional contacts. These connections then help the user to query a subset of the database for information that might be relevant to them. Specifically, by authenticating themselves as a certain user and/or specifying certain search terms, a user initiates a query of the database and is presented with a “news feed” of information nodes, such as items of media, based on his or her relationships with one or more other users.

Through careful study and diligent consideration, the present inventor has come to understand a variety of problems surrounding with current social networking websites which include one in particular, which is three fold. Primarily users must actively choose users with whom they want to connect, with very little a priori information on how their connection with a user will affect the information that is retrieved from the database and shown to them in their news feed. Secondarily, they are not aware of which users are suitable for them to connect with for getting information of interest to them in their news feed. Usually they connect to friends and people they know that also have an on-line presence. However this doesn't guarantee that they will be presented with information that is relevant to them. Lastly most current social networks provide a Boolean on or off relationship model between users. Such a connection is only changed if a user decides to sever an existing connection or create a new connection. This lack of granularity in how much two users are connected results in information overload with respect to information nodes the user doesn't care about and a lack of information in areas where the user has an interest but the retrieved posts lack such content.

Looking at recommendation systems, a recommendation service is a computer-implemented service that recommends nodes from a database of information nodes. One common application for recommendation services involves recommending products to online customers. For example, online merchants commonly provide services for recommending products (books, compact discs, videos, etc.) to customers based on profiles that have been developed for such customers. Recommendation services are also common for recommending Web sites, articles, and other types of informational content to users.

One technique commonly used by recommendation services is known as content-based filtering. Content-based systems operate by attempting to identify nodes which, based on an analysis of node content, are similar to nodes that are known to be of interest to the user. For example, a content-based Web site recommendation service may operate by parsing the user's favorite Web pages to generate a profile of commonly-occurring terms, and then use this profile to search for other Web pages that include some or all of these terms.

Another technique commonly used is item-based collaborative filtering. Item-based collaborative filtering systems keep track of which nodes of information are associated with each other. For example an on-line retailer could associate a node containing computer information with a node containing printer information based on the fact that lots of user that bought a computer also bought a printer.

Content-based systems have a significant limitation in that they generally do not provide any mechanism for evaluating the quality or popularity of a node amongst users. Item-based filtering also has limitations, namely the recommendations are not personalized based on a specific user but rather based on what items most users associate with another item. That is the recommendation is based on what most other users believe to be interesting, this recommendation fails to satisfy users who fall out of the norm of “normal” node-to-node association.

What is desirable for a user is a method that irrespective of a specific application helps them be presented with ranked search results that are personalized to them. Specifically whether a user is querying a database for World Wide Web documents, user contributed posts of interest or products they may want to purchase, the method described herein helps users with cross application personalization of search results.

The present invention includes a method for the creation of a social graph between users of a database where each user's social graph is then used to improve the ranking of results after they've performed a query of the database. Specifically the method allows users to promote search results they find interesting; the method then creates a table of connections between any two users who promote the same node, with a degree of connectedness, equal to how many nodes they have commonly promoted to date. The method then ranks search results for a specific user, based on what nodes other users that they are connected to have found more interesting. This method for presenting search results allows the user to be presented with results ranked in a manner that is more relevant to them in their social context.

The following description is provided to enable any person skilled in the art to make and use the disclosed inventions and sets forth the best modes presently contemplated by the inventor of carrying out their inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the substance disclosed. These and other advantages and features of the invention will be more readily understood in relation to the following detailed description of the invention, which is provided in conjunction with the accompanying drawings.

It should be noted that, while the various figures show respective aspects of the invention, no one figure is intended to show the entire invention. Rather, the figures together illustrate the invention in its various aspects and principles. As such, it should not be presumed that any particular figure is exclusively related to a discrete aspect or species of the invention. To the contrary, one of skill in the art would appreciate that the figures taken together reflect various embodiments exemplifying the invention.

Correspondingly, referenced throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

### BRIEF DESCRIPTION OF DRAWINGS

FIG. 1A shows certain aspects of a method of operation of a search and re-ranking system and apparatus according to principles of the invention;

FIG. 1B shows certain aspects of a method of operation of a search and re-ranking system and apparatus according to principles of the invention;

FIG. 2 shows an exemplary list of nodes presented as a search result that a user might find interesting according to principles of the invention;

FIG. 3 shows an exemplary table of nodes and associated users who are promoting them according to principles of the invention;

FIG. 4 shows an exemplary table of user pairs that have promoted the same nodes in a database according to principles of the invention;

FIG. 5 shows an exemplary table of nodes with associated rankings based solely on a user query according to principles of the invention;

FIG. 6 shows an exemplary table that is the result of the first re-ranking method as applied to nodes from FIG. 5 according to principles of the invention;

FIG. 7 shows an exemplary table of users that have commonly promoted nodes with user A, sorted from most to least number of common nodes;

FIG. 8 shows an exemplary table that is the result of the second re-ranking method as applied to nodes from FIG. 5 of the present invention;

FIG. 9 shows an exemplary table that is the result of removing redundancy while keeping the ranking order from FIG. 8 of the present invention;

FIG. 10 is an illustration of an application of the method to help users in a local community search and find local information;

FIG. 11 is an illustration of personalized list to help users in a local community search and find local information; and

FIG. 12 shows an example of a mounted display device to be put in public places for input/output functions providing access to a database according to principles of the invention.

### DETAILED DESCRIPTION

The following description is provided to enable any person skilled in the art to make and use the disclosed inventions and sets forth the best modes presently contemplated by the inventor of carrying out his inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the substance disclosed.

It will be understood by one of skill in the art that the various methods embodying the invention presented herewith are to be effected by the operation of an information processing device such as, for example, a digital electronic microprocessor. Moreover, in various embodiments, such a microprocessor will be provided along with system components including system memory and communication components. More broadly, the information processing device is coupled by communication components to a broader communication network (for example the Internet) formed of additional communication components, memory components and processors.

In order to perform the various processes and activities discussed herewith, memory components are controlled to establish particular physical states that encode, in definite fashion, information and machine instructions related to the present invention. That is to say, in certain aspects of the invention, respective memory devices are adapted to operate so as to undergo a measurable transformative physical reconfiguration, i.e., a transformation of matter. Consequently the particular switch settings required to perform a search and ranking according to principles of the present invention are stored as a measurable physical state of the memory device. One of skill in the art will understand that, in certain embodiments, certain of these switch settings are substantially permanent inasmuch as they embody one or more of the operation of a fuse device, a read-only memory device, a programmable read-only memory device, a flash memory device, a magnetic memory device or any other memory device as presently known, or as becomes known in the art. The electronic process which serves to establish the requisite switch settings is thus effective to create a particular and dedicated machine.

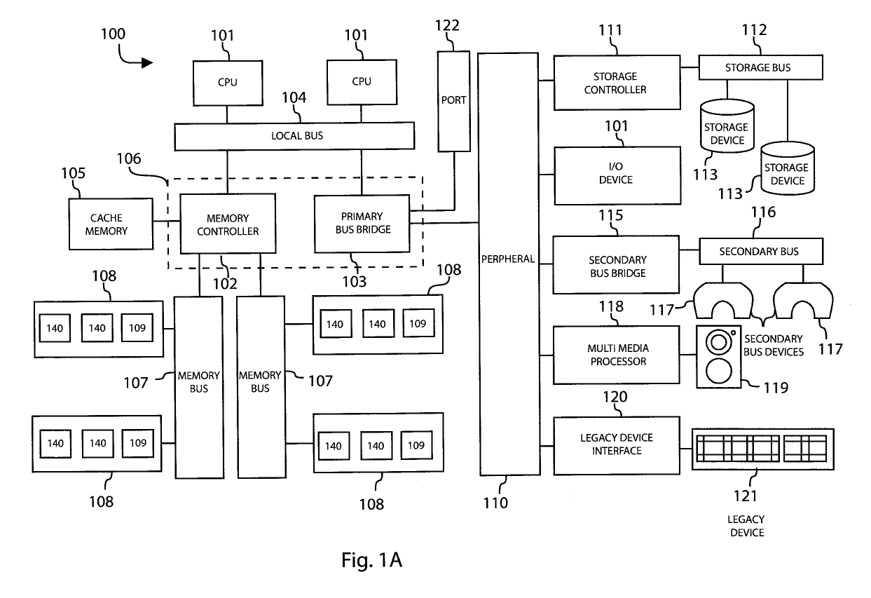

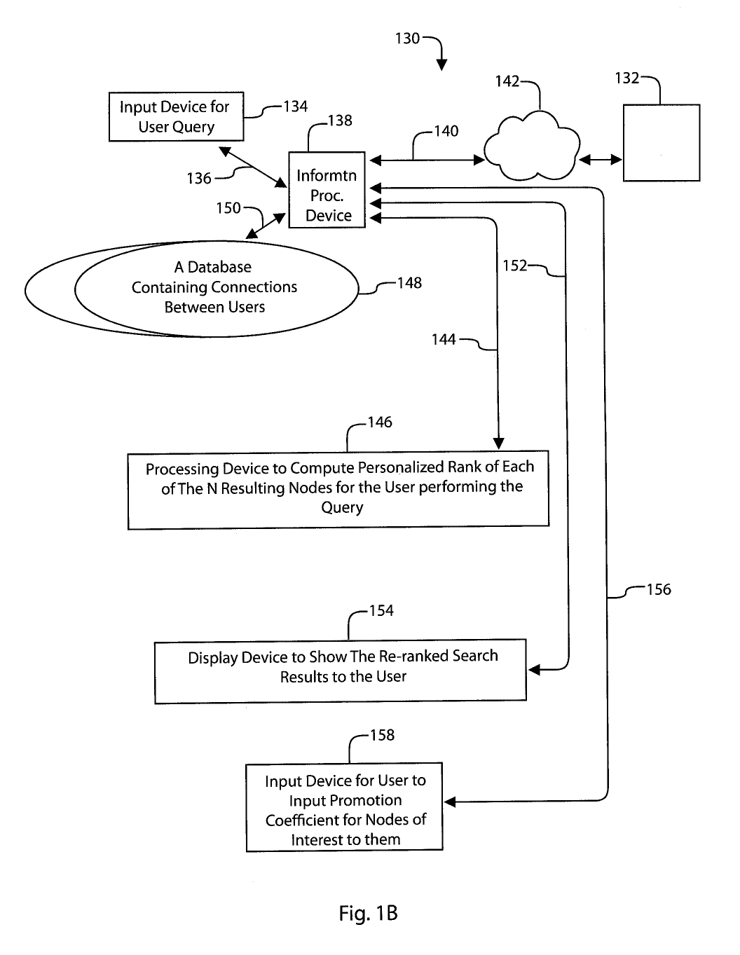

FIG. 1A illustrates, in block diagram form, an exemplary processing system 100 which will be configured to perform all or a portion of a method according to principles of the invention. Those of skill in the art will appreciate that the illustrated embodiment is in no way limiting and that a wide variety of other hardware including electronic hardware, optical hardware, and quantum computing hardware, will be readily configured as ancillary and/or alternative components of a system and apparatus according to the invention. The processing system 100 includes one or more processors 101 coupled to a local bus 104. A memory controller 102 and a primary bus bridge 103 are also coupled the local bus 104. The processing system 100 may include multiple memory controllers 102 and/or multiple primary bus bridges 103. The memory controller 102 and the primary bus bridge 103 may be integrated as a single device 106.

The memory controller 102 is also coupled to one or more memory buses 107. Each memory bus accepts memory components 108, which include at least one memory device configured according to principles of the invention. Alternatively, in a simplified system, the memory controller 102 may be omitted and the memory components directly coupled to one or more processors 101. The memory components 108 may be a memory card or a memory module. The memory components 108 may include one or more additional devices 109. For example, the additional device 109 might be a configuration memory. The memory controller 102 may also be coupled to a cache memory 105. The cache memory 105 may be the only cache memory in the processing system. Alternatively, other devices, for example, processors 101 may also include cache memories, which may form a cache hierarchy with cache memory 105. If the processing system 100 include peripherals or controllers which are bus masters or which support direct memory access (DMA), the memory controller 102 may implement a cache coherency protocol. If the memory controller 102 is coupled to a plurality of memory buses 107, each memory bus 107 may be operated in parallel, or different address ranges may be mapped to different memory buses 107.

In the illustrated embodiment, the primary bus bridge 103 is coupled to at least one peripheral bus 110. Various devices, such as peripherals or additional bus bridges may be coupled to the peripheral bus 110. These devices may include a storage controller 111, a miscellaneous I/O device 114, a secondary bus bridge 115, a multimedia processor 118, and an legacy device interface 120. The primary bus bridge 103 may also be coupled to one or more special purpose high speed ports 122. In a personal computer, for example, the special purpose port might be the Accelerated Graphics Port (AGP), used to couple a high performance video card to the processing system 100.

The storage controller 111 couples one or more storage devices 113, via a storage bus 112, to the peripheral bus 110. For example, the storage controller 111 may be a SCSI controller and storage devices 113 may be SCSI discs. The I/O device 114 may be any sort of peripheral. For example, the I/O device 114 may be an local area network interface, such as an Ethernet card. The secondary bus bridge may be used to interface additional devices via another bus to the processing system. For example, the secondary bus bridge may be an universal serial port (USB) controller 116 used to couple USB devices 117 to the processing system 100. The multimedia processor 118 may be a sound card, a video capture card, or any other type of media interface, which may also be coupled to one additional devices such as speakers 119. The legacy device interface 120 is used to couple legacy devices, for example, older styled keyboards 121 and mice, to the processing system 100.

FIG. 1B shows, in block diagram form, an overview of a method 130 of operating an information processing device according to principles of the invention. Specifically an information processing device, such as device 100 of FIG. 1A, includes a central processing unit and a memory. The memory is configured to include a plurality of functional modules for controlling information. In certain embodiments, the functional modules and controlled information will be arranged as one or more data structures. In other embodiments, the functional modules and information will be tabular, while still other embodiments will use a combination of structures. The functional modules, along with the controlled information, constitutes a database 132 that contains M nodes, where M is any computationally feasible number.

A user makes a query 134 by, for example, interacting with a user interface device. The user interface device receives the query as a change of physical state and produces a query signal 136 by which it communicates the query to the information processing device 138. The information processing device 138 receives the query signal 136 and operates on that query signal by retrieving 140 information previously encoded into memory devices as the database 132. The retrieved information is related to a physical storage location where additional information is encoded in one or more additional memory devices. One of skill in the art will appreciate that the physical storage location may be physically and logically remote 142 from the processor without in any way limiting the present method.

The physical storage locations correspond to logical nodes. It will be appreciated that in certain embodiments of circumstances this correlation will be substantially permanent, while in other embodiments and circumstances the correlation will be dynamic. Notwithstanding any change that may subsequently take place in the physical storage location, at a particular time related to the query, the correspondence will be effective to allow retrieval of desired information. Accordingly, in a certain exemplary query, the information processing device will receive encoded information ultimately corresponding to the physical addresses related to, for example, N nodes; N is any computationally feasible number that is less than or equal to M that is N≦M. The information processing device 138 will then operate 144 to rearrange 146 the N resulting nodes based on certain connections of the particular user making the inquiry with other users of the database 148. It will be appreciated, by one of skill in the art, that the rearrangement may include, among other operations, an identity rearrangement that results in the resulting arrangement being the same as the original arrangement.

The connections will be information encoded within further memory structures configured represent a further database 148. The further database 148 will be accessible 150 by the information processing device for the storage and/or retrieval of information. It is apparent to one of skill in the art that this further database 148 maybe separate and discrete, or maybe encompassed within the broader database 132, according to the arrangement of a particular embodiment of the invention. Subsequent to rearrangement 146 of the nodes N, information related to the resulting arrangement will be conveyed by a signal 152 to a display device 154. As shown, signal 152 may originate directly with the information processing device 138, or may be provided by a further display control device.

As will be further explained below, the information processing device 138 will, in certain embodiments of the invention, receive an additional signal 156 from a user input device 158. The additional signal 156 will relate to an additional user input received at user input device 158 and related to the adjustment of a user promotion coefficient where, according to principles of the invention, the input promotion coefficient relates to a level of interest of the user as to the information content of a node. It will be appreciated that user input device 158 and user input device 134 may be a common user and device or maybe separate and discrete devices.

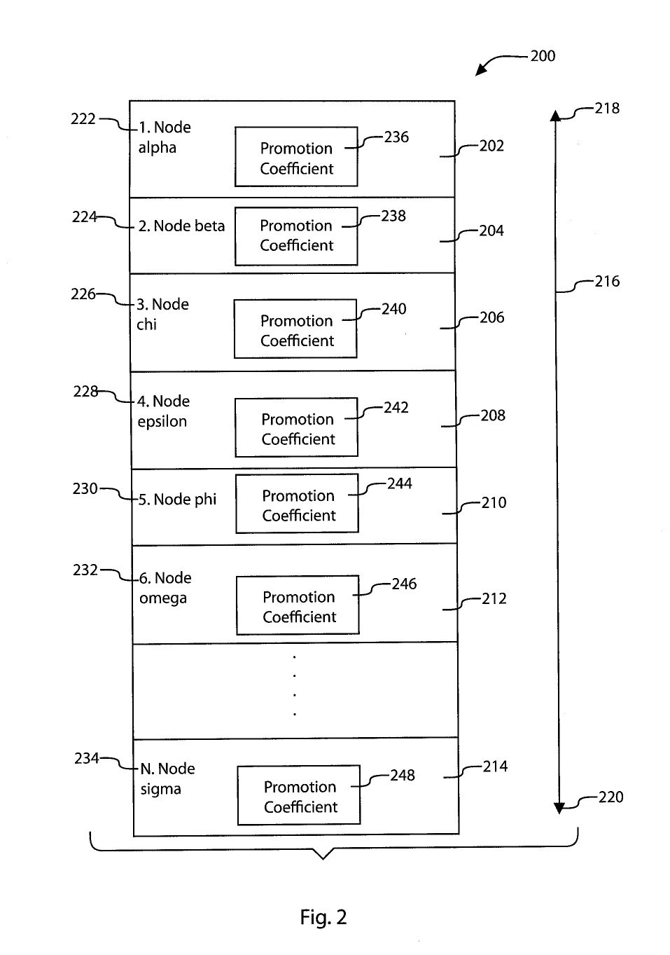

FIG. 2 shows, in block diagram form, an exemplary list 200 of N nodes, for example, 202, 204, 206, 208, 210, 212, 214. As discussed above, the list is presented to a user based on a specific database query entered by that user. The reader will appreciate that the presentation of the individual notes can be provided in a variety of different formats and arrangements. Thus, in certain embodiments, node listing 200 will be presented as a textual listing of an Internet Protocol logical address. In other embodiments, node listing 200 were presented as a graphical representation summarizing information to be retrieved from the Internet protocol logical address, and in other embodiments, combinations of the foregoing will be employed.

It will be appreciated that the presentation of nodes will have an arrangement 216 corresponding to a prioritization of the nodes e.g., high-priority 218 and low priority 220. In certain embodiments of the invention, this arrangement 216 and prioritization will, in various embodiments, be indicated to a user by the inclusion of a numerical value, e.g., 222, 224, 226, 228, 230, 232, 234. In other embodiments according to the invention, prioritization will be indicated by a spatial and graphical arrangement of the information presented. In still other embodiments, prioritization maybe indicated by optical and other sensory effects including, without limitation, color, patterning, tactile feedback, and temperature feedback, tonal or other audible feedback and any other method of indication found to be useful according to the purposes and requirements of a particular application of the invention.

The presentation of the nodes, e.g. node listing 200, to the user will be made through the action of a display device such as display device 154 of FIG. 1B. Consistent with certain embodiments of the invention, the user will be able to access and input device such as input device 158 of FIG. 1B so as to choose to view and promote one or many of the nodes. The number of nodes N is variable and can change depending on the total number of nodes M and/or the search query. The user will then assign a promotion coefficient pc e.g., 236, 238, 240, 242, 244, 246, 248, relating to the information of a particular node, where R1≦pc≦R2. It will be understood that R1 and R2 describe a range of values that promotion coefficient pc can take on. According to certain embodiments of the invention, a new user of the database must have at least one connection with another user before the invention, as herewith presented, can be re-ranked for the user. An exemplary process by which such connections are created is explained further below.

As a design parameter, a user can be given a limited number of choices for the value of pc. Also as a design parameter the method can allow for a user to promote 0, 1, 2, . . . up to N nodes after any database query. For example if, in a particular embodiment, a user is allowed to promote 2 nodes after a database query; and we have a particular user A, then user A can, according to the present example, promote node alpha and node chi, each with an associated promotion coefficient. Information related to the promotion of a particular node, i.e., the establishment of a particular value of pc as it relates to a particular user and node, will be stored by physical encoding, according to certain embodiments, in a database such as database 148 of FIG. 1B. It will be appreciated that the database can have as many users accessing it as is computationally feasible, and that this number of possible users may change consistent with changes, including advancements, in technology. For simplicity we consider the case of six users, namely users: A, B, C, D, E, F.

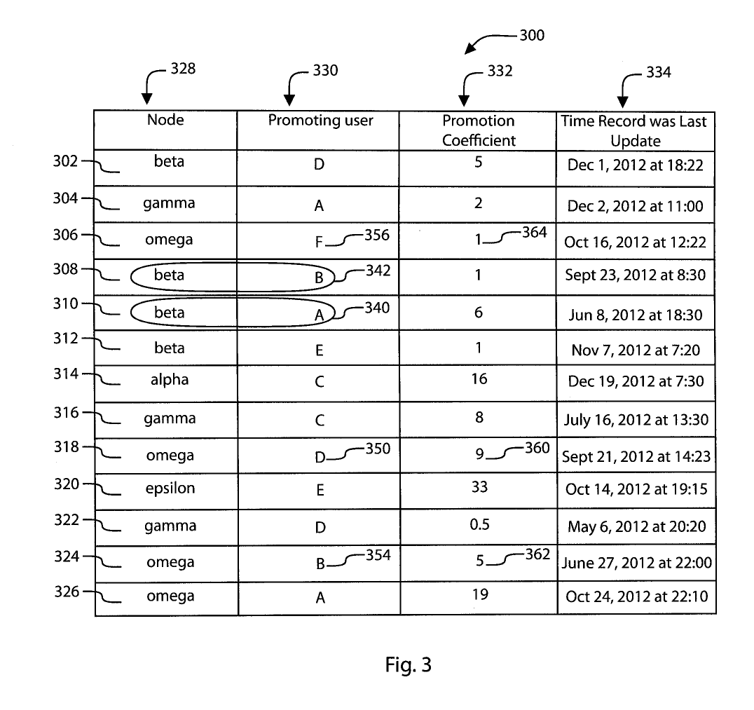

Referring now to FIG. 3, a table 300 is created with the nodes 302, 304, 306, 308, 310, 312, 314, 316, 318, 320, 322, 324, 326 being promoted in a first column 328. Also, as illustrated, the associated user promoting the respective node is shown in a second column 330, followed by the promotion coefficient in the third column 332. The user or system can change the promotion coefficient for each row, the time of last update to each row is recorded in the fourth column 334. The table 300 will be changed according to signals received from the information processor as users decide to promote additional nodes with an associated pc; based on whether the node is relevant to their query.

It should be noted that FIG. 3 shows the table at a particular time, or operational state, when one or more users have viewed and promoted some nodes during one or more previous queries. It will be appreciated that the tabular representation of FIG. 3 may or may not correspond to a logical and/or physical representation and/or location of the actual data as ultimately encoded in physical memory, but is presented here for illustrative purposes.

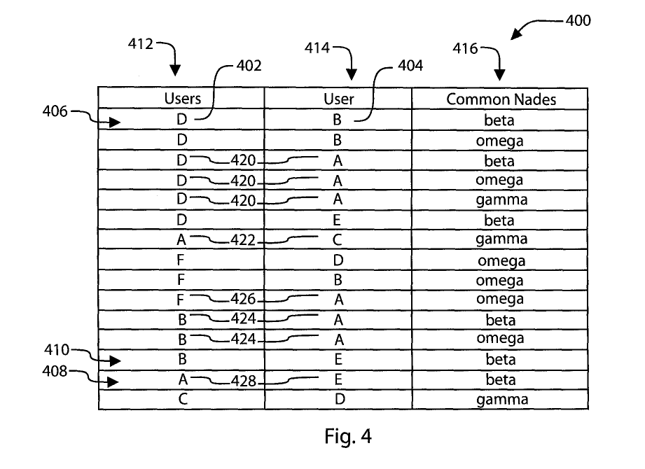

Referring now to FIG. 4, a table 400 showing users and promoted nodes. It will be appreciated that, as in FIG. 3, the tabular representation of FIG. 4 is employed for clarity of presentation, and may or may not represent actual arrangement of data, or of physical devices encoding data. Table 400 is constructed to record pairs of users which have promoted the same nodes thus far. For example, users D 402 and B 404 are associated as an exemplary pair of users 406.

Each time a user promotes a node they have not previously promoted with any promotion coefficient, a number of rows equal to the number of users who have previously promoted the same node (this information is found in FIG. 3), are added to the table to record commonly promoted nodes between any two users. For example if Node beta had previously been promoted by users A 340 and B 342 (see FIG. 3), and user E decides to promote this node with a promotion coefficient, 2 new rows are added to record the new common promotions between users A and E 408 as well as B and E 410.

The table 400 has three columns; the first 412 and second 414 columns contain any two users who have promoted the same node. The third column 416 is a commonly promoted node. Still referring to FIG. 4, the information contained in table 400 is redundant and is a re-arrangement of part of the information shown in table 300 of FIG. 3. Table 400 is created, in certain embodiments, purely to decrease computational complexity, specifically to decrease the time it takes to compute the node weight described below.

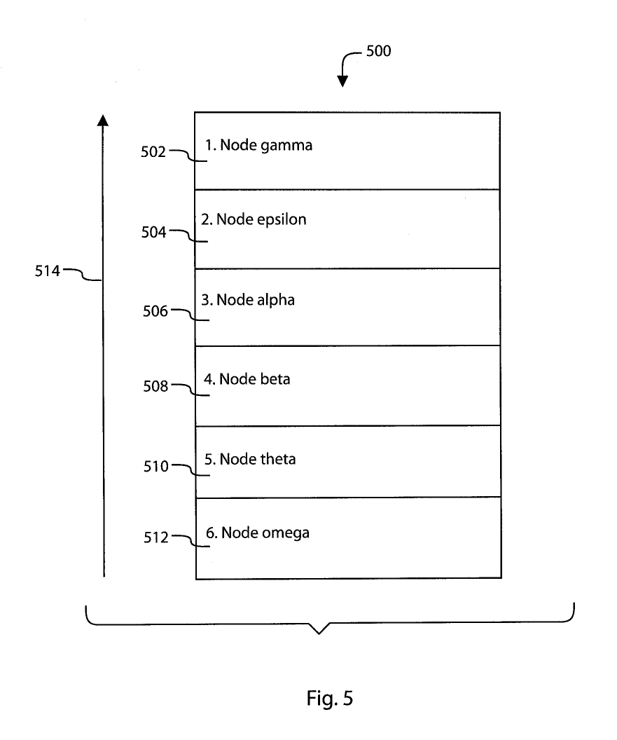

Referring now to FIG. 5, we see a list 500 representing the results of a database query by user A, where the order of nodes e.g., 502, 504, 506, 508 510, 512 has not been reranked or pre-prioritized, but represents a default order 514, or prioritization, returned in response to the search query.

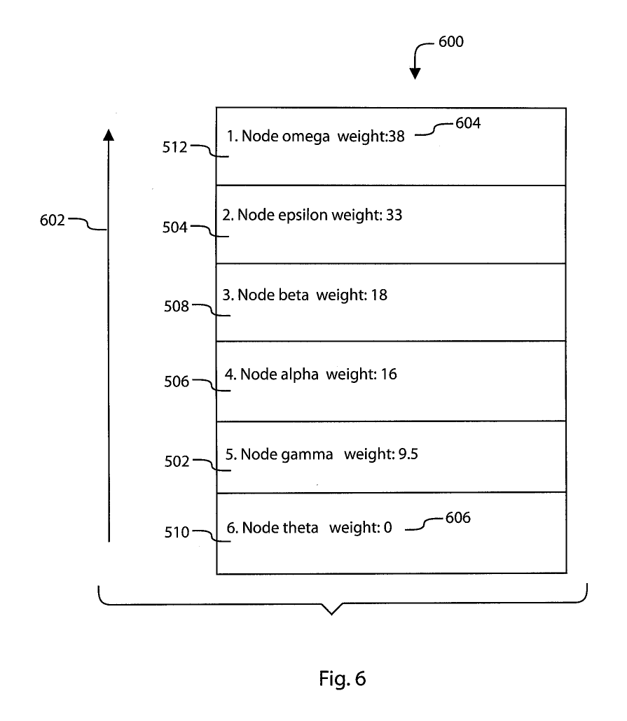

Referring now to FIG. 6, we see a further list 600 of nodes, e.g. 502, 504, 506, 508, 510, 512. List 600 shows a result of a method, according to principles of the invention, for re-ranking 602 of the database query results originally shown in this 500 of FIG. 5. For a given user, say user A, the list of FIG. 6 is advantageous because it rearranges the nodes 512, 504, 508, 506, 502, 510 previously presented in list 500 of FIG. 5 based on how popular each node is amongst users that have previously promoted the same nodes as the active user, A.

The popularity of each node is calculated by following formula. Referring to the list 500 of FIG. 5, we apply the formula below to each node in list 500.

$$weight {node}_{j for user A} = W + {\sum }_{{i ∈ users with}_{{commonly promoted}_{nodes as user A}}} U ( common {nodes}_{iA} ) \times L ( promotion {coefficient}_{ij} )$$

Where W, U, L are design parameters constants that can be adjusted. j is any node from list 500 and i is any user with whom user A has commonly promoted a node to date. The re-ranked version of list 500 is shown as list 600 in FIG. 6. Still referring list 600 of FIG. 6 the nodes are ranked from the node with most weight 512 to the node with the least weight 510, with node omega 512 being the most weighted node with weight thirty-eight 604 and node theta 510 the least weighted node with weight zero 606.

Still referring to FIG. 6, for the sake of clarity we'll illustrate how we calculate the weight of node omega 512 for user A to be thirty-eight 604. We assume the value for constant W to be 0, U to be 1 and L to be 1. To determine the users with common promotions as user A, we refer to table 400 of FIG. 4. We ascertain that only five users D 420, C 422, B 424, F 426, E 428 have promoted nodes in common with user A.

To determine the promotion coefficient which will be associated with node omega with respect to the present search by user A, one refers to table 300 of FIG. 3. Table 300 shows that only three of the five users identified above using table 400 have previously promoted node omega. Referring to table 300 of FIG. 3 these three users are D 350, B 354, F 356. Users C and E, although they have promoted nodes in common with user A in the past, have not promoted node omega, and therefore do not contribution any promotion coefficient to the instant reranking. The promotion coefficients of users D 350, B 354 and F 356, i.e., 360, 362 and 364 respectively will contribute. We then proceed to calculate each sum in the above formula

$$weight {node}_{omega for user A} = {\sum }_{i ∈ D , C , B , F , E} ( common {nodes}_{iA} ) \times ( promotion {coefficient}_{i omega} ) = ( common {nodes}_{DA} = 3 ) \times ( promotion {coefficient}_{D omega} = 9 ) + ( common {nodes}_{CA} = 1 ) \times ( promotion {coefficient}_{C omega} = 0 ) + ( common {nodes}_{BA} = 2 ) \times ( promotion {coefficient}_{B omega} = 5 ) + ( common {nodes}_{FA} = 1 ) \times ( promotion {coefficient}_{F omega} = 1 ) + ( common {nodes}_{EA} = 1 ) \times ( promotion {coefficient}_{E omega} = 0 ) = 38$$

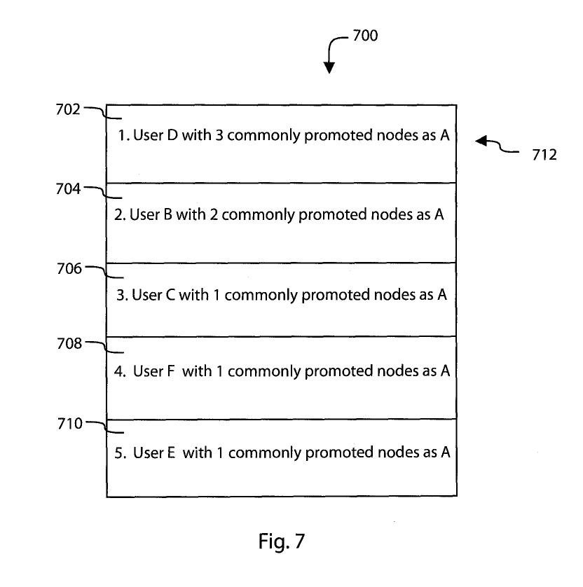

FIG. 7 shows a table 700 constructed, according to principles of the invention, by the following steps:
1. Identify and create a row for each user: m, with whom user A shares commonly promoted nodes, (e.g., user D 702, user B 704, user C 706, user F 708 and user E 710) as described in FIG. 4. A memory device receives and stores encoded data corresponding to this step.
2. Rearrange the above user rows by the number of nodes commonly promoted between the user m and user A, from the most number of nodes in common to the least number of nodes in common. A processor performs the indicated rearrangement and a memory device receives and stores encoded data corresponding to this further step.

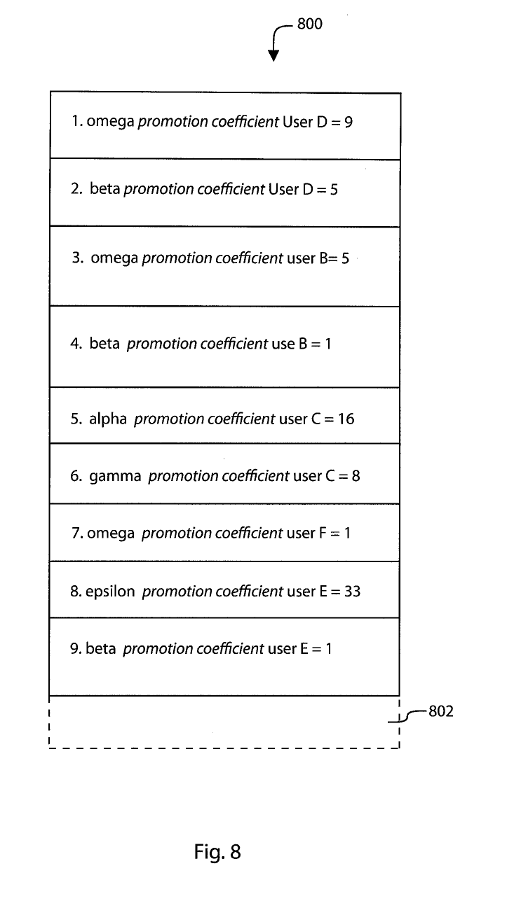

FIG. 8 shows a table 800 constructed, according to principles of the invention, by the following steps:
1. Starting from the top user row 712 of table 700 as shown in FIG. 7, for the user m find the nodes that are: promoted by user m with a non-zero promotion coefficient and are also part of the results of query as listed in list 500 shown in FIG. 5.
2. Sort the nodes found in the previous step from highest to lowest promotion coefficient given by user m.
3. After sorting the nodes in the previous step, keep the first V nodes, where V is an arbitrary constant. For one example, we take V to be 2. If the number of nodes from the previous step is less than V, keep all of the nodes from the previous step.
4. Add an additional row (e.g., 802) to table 800 of FIG. 8 for each of the nodes from the previous step. If there are no rows in the table, create the table and add a row for each of the nodes from the previous step.
5. Repeat steps 1 through 4 for each user found in table 700 of FIG. 7 until no more users remain.

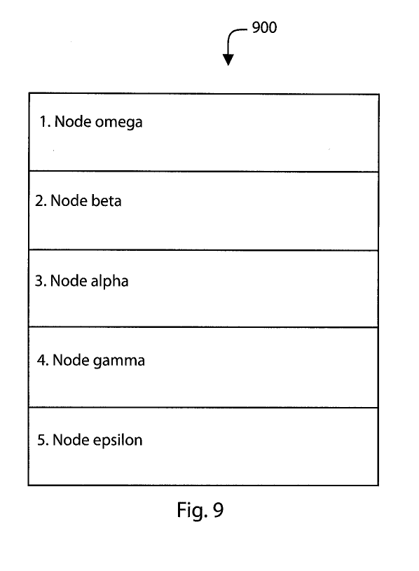

Referring now to table 900 in FIG. 9, we yet provide another method for re-ranking the nodes first shown (un-reranked) in list 500 of FIG. 5. As seen in this 900, the advantage of this method is to provide a user, say user A, with the nodes that other users who are most like them are promoting with any promotion coefficient. As will be understood by one of skill in the art, we take the following intermediary steps to arrive at table 900.

Table 900 is formed by the following steps:
1. Copy the first row from table 800 of FIG. 8 to the first row of table 900 in FIG. 9.
2. Iterate through the remaining node rows (row 2 through last row) in FIG. 8 by adding a row for each node to the bottom of table 900 in FIG. 9 only if the node has not been previously added to the invention in FIG. 9.

Still referring to table 900 in FIG. 9, a table is created with the nodes from the invention of FIG. 8, after removing redundant rows of the same node, keeping the highest ranking of each node row from the invention of FIG. 8.

Any of the tables, lists and arrangements of FIG. 6, FIG. 8 or FIG. 9, can be presented to user A by way of, for example, a processor device and a user interface display device. User A can now decide to view and/or promote any or none of the items in the aforementioned inventions according to how relevant they find a node to their query.

The advantages of the present invention include, without limitation, a method by which users with previously commonly promoted nodes, can implicitly help other users to view a personalized ranked results list from a database query. Specifically, when an active user conducts a query of the database, the current method helps him view a re-ranked version of the query results based on how relevant the found nodes were to other users with similar interests. We call users with whom a user has commonly promoted nodes, their crowd.

The re-ranking of the nodes presented in table 500 of FIG. 5, resulting, for example, in table 800 of FIG. 8 and table 900 of FIG. 9, gives a user a sense of what nodes other users, who are most like them, found relevant. In contrast, the re-ranking described in table 600 of FIG. 6 brings to the user's attention nodes that are most popular among all the users in the user's crowd, not just those most like him.

Still referring to the advantages of the present invention; users of the present method can greatly benefit from the ease by which they become connected to similar users and benefit from their previous observations. By just specifying a promotion coefficient for a node, they become connected to every other user that has specified a promotion coefficient for the same node. This is in contrast to most available web-based social networks where a user must proactively specify which other user he/she wants to connect to, most times with little information on how similar the other user is to them.

Still referring to the advantages of the present invention; in most traditional social graphs the relationship between two users is a binary one, in other words there is a binary degree of how connected two users are to each other. In the present method the non-binary number of commonly promoted nodes allows each user to get a sense of how similar they are to other users in their crowd, and to allow re-ranking according to this user similarity even in the absence of the user being aware of such similarity. The number of commonly promoted nodes creates a continuous granularity for the connectedness of two users. This granularity allows improved re-ranking of search results in a manner that is more relevant to a user.

Still referring to the advantages of the present invention; the type and format of information contained in a database node, does not affect the connectivity between users who decide to promote the node. Thus connections created from common promotion of one type of information node can be used to personalize search results for any other query irrespective of the type of information contained in the returned nodes. For example if two users have a connection based on their common promotion of a music video document on the World Wide Web, the same connection will be used by the present method to personalize what music files to purchase when the user queries the database for music files of interest to them. This cross-application adaptability of the present invention presents a significant advantage over personalization methods that are specific to the format of the information node.

### Professional and Consumer Applications of the Invention

An application of the present invention includes, without limitation, an on-line social networking platform where users develop connections with other users based on their use of a commonly accessible database. These users form a community, where each user can post, search, view and promote (by specifying a promotion coefficient) nodes of relevant information in the database.

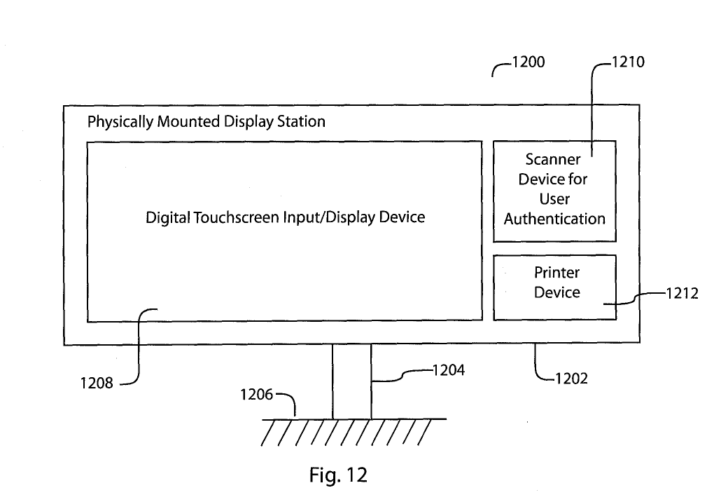

Without intending to be limited in any way, the Inventor herewith provides a list of communities groups, and/or organizations that can benefit from such a social networking platform.

| | |
|---|---|
| Type of | A community of residents of a geographical area, such |
| Community | as a neighborhood, town or city. |
| Type of | Events, happenings, sales specials, pictures, nightlife |
| Information | information, media or any type of information they |
| Posts to | find interesting. |
| Database Node | |
| Use Case | People who have similar taste in local happenings and |
| | information will be connected and the information in |
| | their crowd feed will contain happenings from people |
| | with whom they are connected with, sorted in relation |
| | to the strength of the connection. |
| Input Device | Laptop, Desktop, Mobile Device or Device in FIG. 12. |
| for Creating | |
| Database Query | |
| Display Device | Laptop, Desktop, Mobile Device or Device in FIG. 12. |
| for Viewing | |
| Results | |

One such community are residents of a geographical area, such as a neighborhood, town or city. Members of such a community can post events, happenings, sales specials, pictures, nightlife information, media or any type of information they find interesting, to a commonly accessible database. A user can then search for posts with attributes such as posts related to a certain town or posts containing a specific keyword, that were contributed by other community members.

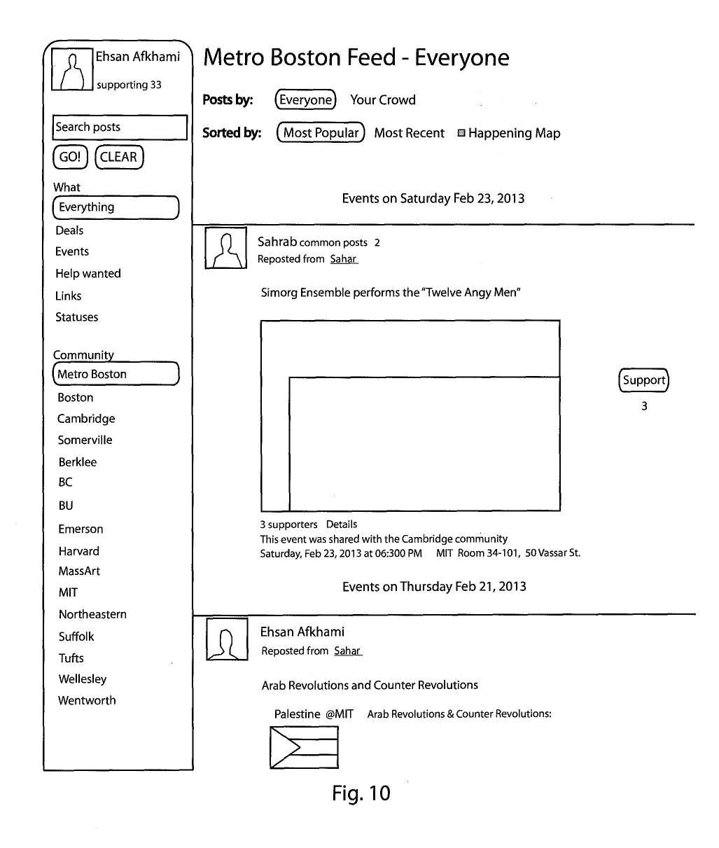

FIG. 10 illustrates the result of such a query. After results are returned a user can promote a post he or she finds interesting by specifying a promotion coefficient for that post. Connections are created, by the action of a processor device, between this user and other users that have promoted the same information posts, based on the method described above. A list containing the latest posts being promoted by the user's local connections or crowd is then created; we call this a user's crowd feed. The crowd feed will help the user stay abreast of the latest local information that are of interest to them.

It should be noted that, while the preceding description suggests an active promotion of a particular post by a user, it is also contemplated by the inventor that other methods of promoting a post will be advantageously employed in relation to the present invention. Thus, for example, a method of evaluating hover time for a mouse/cursor where minor motions of the mouse indicate active observation of the post by a user at the same time localization of the mouse over a particular portion of a screen display can be used to indicate active engagement of the user. Based on the amount of hover time detected, an information processor can assign a particular promotion coefficient to a corresponding node. Likewise, it is anticipated that eye tracking and other motion sensing apparatus are available or will become available such that position, demeanor, ocular activity, and any other measurable quantity will be properly employed in the detection and application of an appropriate promotion coefficient.

It should be noted that in the case of applying such automatic promotion, it is necessary to receive signals produced by particular technical devices in order to effect the method. More generally, however, the present method is specifically technical in nature and is not amenable to manual execution. While some very limited and exemplary approximation aspects of the invention can be performed manually, the speed and breadth of data available in an information processing system is necessary to achieve the full benefit of the invention. This is particularly true because of the nature of certain applications in which a for example, the dynamic schedule upon which happenings, activities, sale opportunities, and other events corresponding to writable information notes requires that treatment of the corresponding information be done extremely quickly. No practical means are available for doing the same on a manual basis, nor, as best known by the inventor, would any such have been conceived prior to the conception of the present invention.

FIG. 10 shows a screenshot of an exemplary embodiment illustrating the use of a method according to the present invention to effect a crowd feed presentation. As an example a parent with young children living in Cambridge Mass. that has an interest in electronic music can search for and promote posts that pertain to their interests in Cambridge. As result of their promotion of certain posts, they develop granular connections with other local residents who have also promoted the same children's events or sound files containing electronic music. The information in their crowd feed will then reflect their interests and location.

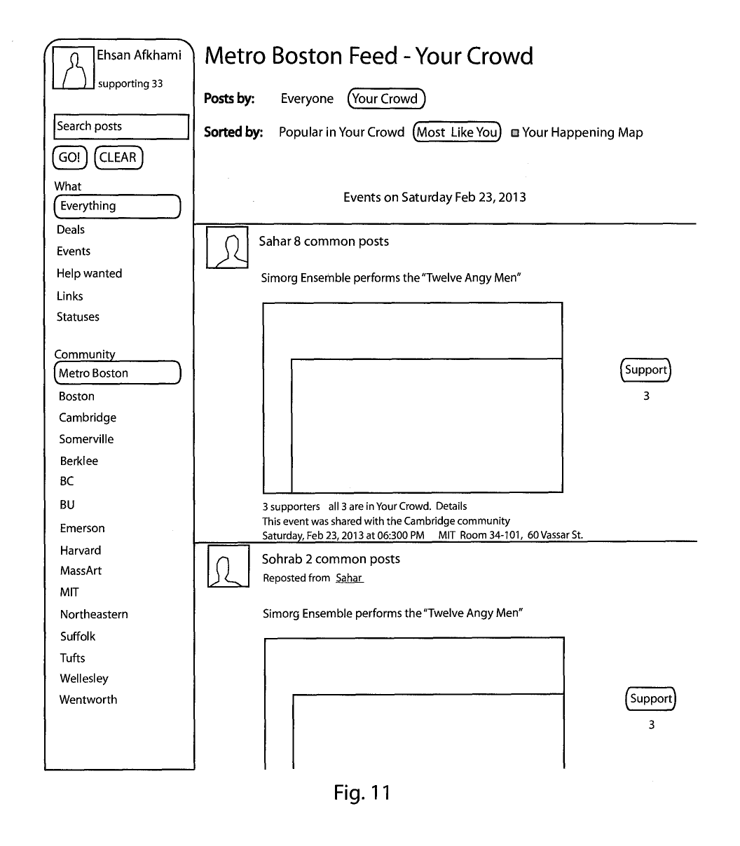

FIG. 11 shows a screenshot of a further exemplary embodiment illustrating the use of a method according to the present invention. According to the illustrated embodiment, a kiosk, as shown in FIG. 12, can be mounted in a public location where users can be authenticated using a barcode or a QR code and a digital scanner. In other embodiments, authentication can be done by automatic communication with a cell phone, personal digital assistant, RFID tag or other device. As part of the embodiment shown in FIG. 11 a printer can print a list of interesting activities occurring in the community that the user will find interesting.

As noted above, FIG. 12 shows a kiosk device 1200 according to one exemplary embodiment of the invention. The kiosk device 1200 includes a weatherproof cabinet 1202 and a support structure 1204. Support structure 1204 is adapted to support the weatherproof cabinet 1202 at a height and in attitude above a supporting substrate 1206, such as the ground. In certain embodiments, the weatherproof cabinet is configured to support a user interface device including, for example, a digital touchscreen input/display device 1208 or other input output device adapted for communication with a user. In addition, certain embodiments of the kiosk device 1200 will include a scanner device or other communication device 1210 adapted to detect a characteristic of an individual or identifying device carried by an individual so that individual can be correlated to a related database (e.g., 148 of FIG. 1 as discussed above).

Still further, certain embodiments of the kiosk device 1200 will include a printer device or other device 1212 for preparing a paper output or other output device including information or having other valuable characteristics. In certain embodiments, the printer device 1212 will provide a printed map to an event. In other embodiments, the printer device 1212 will produce and dispense an admission ticket or a beneficial coupon such as a discount coupon. In certain embodiments, the printer device will encode a technical record including an education information and other relevant information into a microchip, magnetic stripe, optical device such as, for example, a holographic device, or other device within or attached to the ticket or coupon.

| | |
|---|---|
| Type of | Employees of a commercial organization or a non- |
| Community | profit |
| Type of | News bites, documents or short status updates. |
| Information | |
| Posts to | |
| Database Node | |
| Use Case | Employees who find each other's posts informative |
| | will be connected, this will result in the employees |
| | with the most similar information needs to be |
| | connected. An employee will see the most relevant |
| | company information from their connections in their |
| | crowd feed. |
| Input Device | Laptop, Desktop, Mobile Device or Device in FIG. 12. |
| for Creating | |
| Database Query | |
| Display Device | Laptop, Desktop, Mobile Device or Device in FIG. 12. |
| for Viewing | |
| Results | |

| | |
|---|---|
| Type of | Community of online shoppers |
| Community | |
| Type of | Products available for purchase |
| Information in | |
| Database Node | |
| Use Case | Customers that purchase and/or find the same products |
| | interesting will be connected. Each customer will then |
| | receive recommendations from their connections |
| | regarding what are the newest products they should |
| | look into. |
| Input Device | Laptop, Desktop, Mobile Device |
| for Creating | |
| Database Query | |
| Display Device | Laptop, Desktop, Mobile Device |
| for Viewing | |
| Results | |

| | |
|---|---|
| Type of | Community of shoppers in a mall or local shopping |
| Community | district |
| Type of | Products purchased by each shopper. |
| Information | |
| Posts to | |
| Database Node | |
| Authentication | Device in FIG. 12. A scanner or bar code reader. |
| Device | |
| Use Case | Each time a shopper makes a purchase at a particular |
| | store they connect with shoppers who made a purchase |
| | at that store or in the case of a department store at a |
| | particular department of that department store. They |
| | then get a list of recommendations on what the latest |
| | things to buy are from other shoppers that share their |
| | shopping habits. This social networking platform can |
| | also incorporate a loyalty rewards program in |
| | conjunction with its core function. |
| Input Device | Laptop, Desktop, Mobile Device or Device in FIG. 12. |
| for Creating | |
| Database | |
| Query | |
| Display Device | Laptop, Desktop, Mobile Device or Device in FIG. 12. |
| for Viewing | |
| Results | |

| | |
|---|---|
| Type of | A community of learners |
| Community | |
| Type of | Educational documents, videos, notes or other |
| Information | hypermedia |
| Posts to | |
| Database Node | |
| Use Case | Learners interested in the same topic or course |
| | materials from an institution will be connected based |
| | on their interest in the same educational content. A |
| | learner would then be presented with the latest |
| | material posted by people who have similar learning |
| | needs. |
| Input Device | Laptop, Desktop, Mobile Device |
| for Creating | |
| Database Query | |
| Display Device | Laptop, Desktop, Mobile Device |
| for Viewing | |
| Results | |

| | |
|---|---|
| Type of | A community of professionals |
| Community | |
| Type of | Trade magazine articles, documents, videos or other |
| Information | hypermedia relating to a specific trade or profession. |
| Posts to | |
| Database Node | |
| Use Case | Professionals from the same field will be connected |
| | based on their common promotion of the same |
| | information nodes. A professional will then be notified |
| | of what other media other professionals in their field |
| | find interesting. |
| Input Device | Laptop, Desktop, Mobile Device |
| for Creating | |
| Database Query | |
| Display Device | Laptop, Desktop, Mobile Device |
| for Viewing | |
| Results | |

| | |
|---|---|
| Type of | The Community of Web Surfers |
| Community | |
| Type of | URL of a webpage |
| Information | |
| in a | |
| Database Node | |
| Use Case | Each time a user visits a webpage or uses a web search |
| | engine to query for pages, they're presented with a |
| | user interface to assign a promotion coefficient to a |
| | webpage. The placement of this interface maybe done |
| | in collaboration with a search engine company or with |
| | the website owner. This user interface can also be |
| | presented by installing a plugin into a web browser |
| | that has access to the users viewing activity. Through |
| | their common promotion of the same webpage, surfers |
| | with the same webpage viewing habits will be |
| | connected. A surfer is then presented with a listing of |
| | websites that other web surfers with similar viewing |
| | habits find interesting. |
| Input Device | Laptop, Desktop, Mobile Device |
| for Creating | |
| Database Query | |
| Display Device | Laptop, Desktop, Mobile Device |
| for Viewing | |
| Results | |

| | |
|---|---|
| Type of | A community of commenters on webpages |
| Community | |
| Type of | Comments, posted by users of a webpage, associated |
| Information | with hypermedia on a webpage |
| Posts to | |
| Database Node | |
| Use Case | Each time a user visits a webpage where they can view |
| | or add comment, they're presented with a user |
| | interface to assign a promotion coefficient to an |
| | existing comment on the webpage. The placement of |
| | this interface will be done in collaboration with the |
| | website owner. This user interface can also be |
| | presented by installing a plugin into a web browser |
| | that has access to the users viewing activity. |
| | Through their common promotion of the same |
| | comment, surfers with the same comment viewing |
| | habits will be connected. A surfer is then presented |
| | with a listing of comments and their associated |
| | webpages that other web commenters with similar |
| | commenting habits find interesting. |
| Input Device | Laptop, Desktop, Mobile Device |
| for Creating | |
| Database Query | |
| Display Device | Laptop, Desktop, Mobile Device |
| for Viewing | |
| Results | |

| | |
|---|---|
| Type of | Community of traders and enthusiasts of financial |
| Community | instruments |
| Type of | URLs, a comment post, trade information or |
| Information | hypermedia |
| Posts to | |
| Database Node | |
| Use Case | Investors interested in the same market sector or |
| | financial instrument are connected. An investor or |
| | enthusiast is presented with a list of trades or |
| | hypermedia that other community members with |
| | similar market interests are interested in. |
| Input Device | Laptop, Desktop, Mobile Device |
| for Creating | |
| Database Query | |
| Display Device | Laptop, Desktop, Mobile Device |
| for Viewing | |
| Results | |

| | |
|---|---|
| Type of | Community of job seekers |
| Community | |
| Type of | Job postings, hypermedia, URLs |
| Information | |
| Posts to | |
| Database Node | |
| Use Case | Job seekers with an interest in the same types of jobs |
| | are connected. A job seeker is presented with jobs and |
| | hypermedia that users with similar job interests find |
| | helpful in their job search. |
| Input Device | Laptop, Desktop, Mobile Device |
| for Creating | |
| Database Query | |
| Display Device | Laptop, Desktop, Mobile Device |
| for Viewing | |
| Results | |

| | |
|---|---|
| Type of | Community of users with various maladies |
| Community | |
| Type of | Posts, hypermedia, webpage URLs |
| Information | |
| Posts to | |
| Database Node | |
| Use Case | Users with similar health conditions will be connected |
| | based on their common promotion of information |
| | nodes. A user is then presented with a list of what |
| | other information users with similar illnesses have |
| | found interesting. |
| Input Device | Laptop, Desktop, Mobile Device |
| for Creating | |
| Database Query | |
| Display Device | Laptop, Desktop, Mobile Device |
| for Viewing | |
| Results | |

| | |
|---|---|
| Type of | Community of romantic daters or networkers |
| Community | |
| Type of | User information and profile |
| Information | |
| Posts to | |
| Database Node | |
| Use Case | Users with similar interests in other users of a specific |
| | type will be connected based on their common |
| | promotion of another user. For example men who like |
| | to date women over 6 feet of height will be connected. |
| | Users will be presented with a list of users they may |
| | like and/or contact based on the observations of users |
| | that share their interest in a type of person. |
| Input Device | Laptop, Desktop, Mobile Device |
| for Creating | |
| Database Query | |
| Display Device | Laptop, Desktop, Mobile Device |
| for Viewing | |
| Results | |

The creative practitioner of ordinary skill in the art will appreciate that any of the above applications and/or uses may be employed and/or combined within a further application and/or use.

Still referring to the application of the present invention, a user of the social networking platform based on the methods of the present invention, will be able to use connections developed in one of the aforementioned applications to re-rank results in another application. For example a parent with young children living in Cambridge Mass. that has an interest in electronic music can develop granular connections with other local residents who share and promote children's event posts or sound file posts containing electronic music. These connections can then be used when the same user performs a web search.

For example if the user searches the web for a keyword like “house music”, and the results include websites that one or many of their connections from their local community (Cambridge, Mass.) have previously promoted, based on the described method of the present invention, we can re-rank the search results. This re-ranking utilizes the collective intelligence of the users connections and will result in a more relevant web search based on the users shared web surfing habits and common interest with other local users.

Still referring to the application of the present invention, a World Wide Web document search engine based on the method of the present invention. In such a search engine, the search results will be sorted for each user according to which search results similar users have promoted in the past.

In broad embodiment, the present invention is a method for the creation of a social graph between users of a database where each user's social graph is then used to improve the ranking of results after they've performed a query of the database. The method ranks search results for a specific user, based on what nodes other users that they are connected to have found more interesting. This method for presenting search results allows the user to be presented with results ranked in a manner that is more relevant to them in their social context.

It will be appreciated that, while the user interface devices and information processing devices described above have been generally characterized in terms of a limited subset of the presently available technology, a wide variety communication and information processing technology will benefit from the application of various methods and embodiments of the present invention. In particular, it will be understood by one of skill in the art, that various aspects of the technical processing and communication anticipated and described in this disclosure will be available in a desktop computer, a laptop computer, a mobile computer, a tablet computer, a smart phone or other personal electronic device, a wearable information system including, without limitation, a communicating watch or bracelet, wearable garments including, without limitation, pants, shirts, socks, shoes, hats, coats, dresses, ties and other articles of attire any of which may include the requisite communication and processing equipment that will benefit from the present invention. In addition, it is anticipated that implanted devices including implanted electronic devices may eventually likewise provide effective communication and processing for a user/subject of implantation and/or for those around that person.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method of prioritizing information returned in response to an information query, the method comprising:
receiving a user identification signal at a processor, said user identification signal identifying a first user;
receiving a first query signal at said processor from said first user;
sending a second query signal from said processor to a first memory device, said second query signal reflecting an information content of said first query signal;
responsive to said second query signal, receiving a query response at said processor from said first memory device, said query response including encoded information related to a plurality of information nodes, said plurality of information nodes constituting a query response related to said first query signal, said information nodes having a first order of priority;
receiving a community signal at said processor, said community signal encoded to convey information related to at least a second user, said second user being related to said first user by a common previous user action to indicate interest in a previous response result, wherein said previous response result includes a response result to a query unrelated to said first query signal, and wherein said community signal embodies at least one promotion coefficient, said promotion coefficient reflecting a valuation signal previously initiated by said second user regarding at least one node of said plurality of information nodes; and
applying said community signal to adjust said order of priority of said information nodes.

2. A method of prioritizing information as defined in claim 1 wherein said receiving a community signal at said processor comprises receiving said community signal from a remote server.

3. A method of prioritizing information as defined in claim 1 wherein said receiving a promotion coefficient at the processor comprises receiving said promotion coefficient from a remote server.

4. A method of prioritizing information as defined in claim 1 wherein said first memory device comprises a portion of a remote server device.

5. A method of prioritizing information as defined in claim 1 wherein said first memory device is mutually enclosed in a common cabinet with said processor.

6. A method of prioritizing information as defined in claim 1 wherein said receiving a user identification signal at said processor comprises receiving a user identification signal from an electronic device carried by said first user.

7. A method of prioritizing information as defined in claim 6 wherein said receiving a user identification signal from an electronic device comprises receiving a user identification signal from a cell phone.

8. A method of prioritizing information as defined in claim 6 wherein said receiving a user identification signal from an electronic device comprises receiving a user identification signal from an RFID enabled device.

9. A method of prioritizing information as defined in claim 1 wherein said receiving a user identification signal at said processor comprises receiving a user identification signal from an optically encoded device.

10. An information handling apparatus comprising: an
information processor device;
a memory device operatively coupled to said information processor device, wherein said memory device includes a plurality of multistate devices, said plurality of multistate devices having respective states configured to physically encode a first plurality of operative instructions and a second plurality of data elements, said first plurality of operative instructions selected and arranged to control said information processor device, whereby said information processor device collects respective information sets from a plurality of identified users and encodes said respective information sets within said second plurality of data elements, said respective information sets embodying promotion coefficients previously applied by said plurality of identified users to a plurality of information nodes, said plurality of information nodes having been returned in response to a plurality of previous queries of said plurality of users, such that when said information processor executes a further search, according to said operative instructions, on behalf of a target user, a result of said further search is prioritized according to a subset of said information sets, said subset of said information sets corresponding to those users of said plurality of users who previously applied a promotion coefficient to an information node in common with said target user, and who also previously applied a promotion coefficient to a node returned in response to said further search.

11. An information handling apparatus as defined in claim 10 wherein said information processor device comprises an electronic digital microprocessor.

12. An information handling apparatus as defined in claim 10 wherein said information processor device comprises an electronic digital microcontroller.

13. An information handling apparatus as defined in claim 10 wherein said information processor device comprises an optical computer device.

14. An information handling apparatus as defined in claim 10 wherein said information processor device comprises a quantum computing device.

15. An information handling apparatus as defined in claim 10 wherein said memory device is disposed at a location remote from said information processor device and configured to communicate with said information processor device.

16. An information handling apparatus as defined in claim 10, further comprising a user interface device, said user interface device being disposed at a location remote from said information processor device and being configured to communicate with said information processor device.

17. A memory device, said memory device including a plurality of multistate devices, said plurality of multistate devices configured to encode a control program, said control program controlling a processor, said processor receiving a search query from a first user and receiving a first search result including a plurality of nodes and a first node ranking, said control program controlling said processor to receive a first community signal, said first community signal embodying a list of users, who previously elevated a search result in common with said first user, and a corresponding plurality of promotion codes; said control program controlling said processor to select, from said list, a sublist of users who have also previously elevated a node of said plurality of nodes; and said control program controlling said processor to form a second node ranking reflecting said sublist.

18. A memory device as defined in claim 17 wherein said controlling said processor to form a second node ranking comprises re-ranking said plurality of nodes in relation to certain promotion codes, of said plurality of promotion codes, that correspond to said sublist of users.

19. A memory device as defined in claim 17 wherein said memory device further comprises an electronic memory device.

20. A memory device as defined in claim 17 wherein said memory device further comprises a magnetic memory device.
